(19) United States
(12) Patent Application Publication
(10) Pub. No.: US 2023/0128463 A1
(43) Pub. Date: Apr. 27, 2023

(54) System and Method for Pricing Loan Products

(71) Applicant: PollyEx, Inc., San Francisco, CA (US)

(72) Inventors: Adam Carmel, San Francisco, CA (US); Jon Foy, Meridien, ID (US); Mark Dellacca, Corona, CA (US)

(21) Appl. No.: 17/508,101

(22) Filed: Oct. 22, 2021

(51) Int. Cl. G06Q 40/02; G06Q 20/40; G06Q 30/02

(52) U.S. Cl. CPC G06Q 40/025; G06Q 20/405; G06Q 30/0206

(57) ABSTRACT

A method for a mortgage originator to define a specific mortgage product offered to borrowers, the specific mortgage product defined using a software application accessible via a graphical user interface presented in a display. The method includes establishing, with the software application, a plurality of rules available to apply to unique mortgage products. The method also includes establishing, with the software application, a first unique mortgage product, the first unique mortgage product characterized by at least one of a class, a category, a type, and a structure of the first unique mortgage product. The method also includes configuring, with the software application, a rule group including a combination of rules selected from the plurality of rules; applying, with the software application, the rule group to the first unique mortgage product to define a first specific mortgage product; and applying, with the software application, the rule group to a second unique mortgage product to define a second specific mortgage product.

### BACKGROUND OF INVENTION

### 1. Field of Invention

This invention relates generally to the sale of loans. More specifically, at least one embodiment relates to a system and method for pricing loan products.

### 2. Discussion of Related Art

Today's mortgage market provides lenders with a great variety of product pricing options. These products can include fixed rate mortgages with different length terms and adjustable-rate hybrid mortgages that include a fixed introductory rate during the initial years of the loan and annual interest rate adjustments thereafter. There are many variable factors that can also impact the rate, qualifications, and other elements of these mortgages. These variable factors must be evaluated to establish the rate for any mortgage product. That is, the note rate of a selected loan product is determined using a base note-rate that is modified according to the term-length of fixed rate mortgages (30 year fixed, 15 year fixed, etc.), the structure of the adjustable rate mortgage (10/1 ARM, 7/1 ARM, etc.) and the factors applicable to the loan product. These variable factors may concern the borrower (income, credit score, etc.), the nature of the financial transaction (cash out, loan-to-value ratio, etc.) and the nature of the subject property (single family home, condo, secondary residence, geographic location, etc.)

In practice, the wide variety of mortgage product categories and pricing options creates a complex matrix for loan pricing. Adding to the complexity, different factors applicable to the same mortgage product can push the note rate up or down relative to the base rate, sometimes in opposing directions. Further customization based on factors such as the state where a property is located can also impact the price of a mortgage product. Today's software tools employed in mortgage product pricing have not kept up with this complexity. These product pricing tools are cumbersome and complex for their users. This can result in errors and reduced throughput which negatively impacts revenue by reducing the volume of mortgages that the lender originates.

In general, rules or other logic are applied to the base note rate in the different mortgage product categories to establish the pricing for a particular mortgage product within the product category. As one example, a rule or other form of logic can adjust the rate offered on a 30 year fixed mortgage product based on the borrower's FICO score. In one example, a first mortgage product is priced where a borrower has a FICO score that is at or above an established threshold. In another example, a second mortgage product is priced where a borrower has a FICO score that is below an established score. To establish mortgage product pricing, traditional approaches apply rules or other logic to their suite of mortgage products using a hierarchy structure.

Referring to FIG. 1, a traditional prior art hierarchical structure employed to price mortgage products is illustrated. In general, each product is defined by the class of the mortgage product (conventional), the category of the mortgage product (conforming or high balance), the type of the mortgage product (fixed or ARM) and the structure of the mortgage product (30 year fixed, 15 year fixed, 10/1 ARM or 7/1 ARM).

As illustrated in FIG. 1 a hierarchical loan product structure 100 provides loan products including: a first loan product 110 which is a conventional, conforming, 30 year fixed rate mortgage; a second loan product 112 which is a conventional, conforming, 15 year fixed rate mortgage; a third loan product 114 which is a conventional, conforming, 10/1 ARM, and a fourth loan product 116 which is a conventional, conforming, 7/1 ARM. FIG. 1 also illustrates a similar suite of non-conforming products that are provided for high balance loans.

Typically, there are many separate factors (“parameters”) that are associated with separate adjustments to the base rate of various loan product. These factors are applied to create specific loan products with the note rate determined for the specific loan products offered to borrowers. Typically, the different factors that impact any loan products include the following parameters: 1) a user's FICO score; 2) a loan-to-value ratio (“LTV”); 3) a cash-out of a portion of the loan proceeds by the borrower; 4) an identity of the source of the lead that provides the opportunity to the lender; and 5) a margin provided to the branch originating the loan. Each loan originator may have hundreds of rules or other pieces of logic that may be applied to one or more of their loan products. Further, these different factors can be applied in any combination to create the specific loan product that is offered a particular borrower based on information specific to the borrower and the property that is subject to the mortgage. However, each of the factors must be individually applied to the loan products 110, 112, 114, 116 to create the loan with the note rate that is offered to a selected borrower.

As one example, a first mortgage product is a conventional, conforming 30 year fixed rate mortgage where the FICO score is 579 or greater and the loan-to-value ratio is 20% or greater. This product with the associated note rate is created with the loan originator separately applying a first adjustment for “FICO greater than 579” and a second adjustment “minimum LTV of 20%” to the base note rate to create the product.

A second mortgage product is a conventional, conforming 15 year fixed rate mortgage where the FICO score is 579 or greater and the loan-to-value ratio is 20% or greater. Here, a loan product with an associated note rate is created with the loan originator again required to separately apply a first adjustment for “FICO greater than 579” and then a second adjustment “minimum LTV of 20%” to the base note rate to create this second product. As illustrated by these two examples, a repetitive and inefficient process is created because the pricing logic is manually applied one piece of logic at a time to one product at a time.

According to some prior approaches, the hierarchical approach is used to apply an individual rule to a broad category of loans. For example, a rule “FICO score is 579 or greater” can be applied to all conforming loans in the hierarchical loan product structure 100. The problem with this approach is that there are few if any rules that are universally applicable to all conforming loan products. As a result, the user must manually back out the rule or logic for any conforming loan products for which the rule is not applicable. Alternatively, the user can manually add another rule to negate the effect of the first rule for any conforming loan products for which the first rule is not applicable. The inefficiencies apparent with the preceding are magnified given all the possible variations in loan classes, categories, types, and structures.

Another prior approach is illustrated in FIG. 2. Here, eligibility rules are assigned one rule at a time to one or more mortgage products. FIG. 2 includes eligibility rules 218, adjustments and margins 220, a tagging tool 222 and loan products 224. Multiple rules are included in the eligibility rules 218 and multiple adjustments and margins are included in the adjustments and margins 220. The tagging tool includes a “Fixed” tag 227, and “ARM” tag 228 and a “CA” tag 230. The Fixed tag 227 and the ARM tag 228 refer to the type of loan product. The CA tag 230 refers to the state of California and is applicable to loan products directed to properties located in California. The loan products 224 include two loan products: a first loan product 225 (30 year fixed) and a second loan product 226 (a 5/1 hybrid ARM structure).

FIG. 2 illustrates the application of different factors to establish pricing for the two loan products 225, 226. The first loan product 225 is a fixed interest rate product with a 30 year term. The second loan product 226 is a hybrid adjustable rate mortgage with an interest rate that is fixed for the first five years of the loan and subject to annual adjustments in the interest rate thereafter. To establish the appropriate note rate, the loan originator must review each of the eligibility rules 218 and each of the adjustments and margins 220 to determine whether they apply to the loan product based on the category, type, and structure of the product. The product pricing is established once the relevant rules, and adjustments and margins are separately applied to the respective loan products 225, 226.

As illustrated in FIG. 2, the first listed rule is identified as being applicable to the first loan product 225 because the rule applies to all conforming fixed rate mortgages. The first listed rule is then tagged to apply it to the 30 year fixed rate product. Separately, the second listed rule is identified as being applicable to the first loan product 225 because the rule applies to all conforming fixed rate mortgages with a borrower with a minimum required FICO score. The second listed rule is separately tagged and applied to the second loan product 225. In this example, there are two separate rules that are both applicable to first loan product 225. However, they must be separately tagged and separately applied to the applicable loan products.

The individual adjustments and margins 220 are reviewed and applied to individual loan products in a similar fashion. For example, as illustrated in FIG. 2, a first listed adjustment is identified as being applicable to the first loan product 225 because the rule applies to conforming fixed rate mortgages that do not exceed a maximum sale price of the property subject to the mortgage. The first listed adjustment is tagged and then applied to the first loan product 225.

The rules and adjustments in FIG. 2 may include state specific factors. For example, the fourth listed rule applies to properties that are condominiums located in California. Here, the fourth listed rule is identified as being applicable to the both the first loan product 225 and the second loan product 226 because both the 30 year fixed rate product and the 5/1 ARM are for condominiums located in California. The fourth listed rule is tagged, and it is applied to both loan products 225, 226. Separately, the third listed adjustment is also applicable to properties that are in California. The third listed adjustment is identified as being applicable to the both the first loan product 225 and the second loan product 226. While both the fourth listed rule and the third listed adjustment can be applied to multiple loan products common to each, they are independently tagged and independently applied to the loan products 225, 226.

With the eligibility rules 218, and adjustments and margins 220 applied, the pricing is established for a specific 30 year fixed rate mortgage product. The eligibility rules 218, and adjustments and margins 220 are also reviewed, tagged, and applied to the second loan product 226 in a manner consistent with the above. With the eligibility rules 218, and adjustments and margins 220 applied, the pricing is established for a specific 5/1 ARM mortgage product.

### SUMMARY OF INVENTION

Therefore, there is a need for apparatus, systems and methods for a loan pricing application that provides users with an ability to organize and group rules together and apply the rules together in the groups to any of the user's loan products. According to various embodiments, different rule groups including multiple different rules, respectively, can be applied to loans to impact at least one of: a price level adjustment of a mortgage product to which the rules are applied; a margin on the mortgage product to which rules are applied; and an eligibility of borrowers for the mortgage product to which the rules are applied.

According to one aspect, a non-transitory computer readable medium includes computer program instructions executable by at least one computer processor to perform a method for a mortgage originator to define a specific mortgage product offered to borrowers, the specific mortgage product defined using a software application accessible via a graphical user interface presented in a display. In some embodiments, the method includes establishing, with the software application, a plurality of rules available to apply to unique mortgage products, each of the plurality of rules associated with at least one of: a class of the unique mortgage product; a category of the unique mortgage product; a type of the unique mortgage product; the structure of the unique mortgage product; a factor concerning a borrower of the unique mortgage product; and a factor concerning a nature of a property subject to the unique mortgage product. The method also includes establishing, with the software application, a first unique mortgage product, the first unique mortgage product characterized by at least one of a class, a category, a type and a structure of the first unique mortgage product; and establishing, with the software application, a second unique mortgage product that is different than the first unique mortgage product, the second unique mortgage product characterized by at least one of a class, a category, a type and a structure of the second unique mortgage product.

According to various embodiments, the method includes configuring, with the software application, a rule group including a combination of rules selected from the plurality of rules; applying, with the software application, the rule group to the first unique mortgage product to define a first specific mortgage product; and applying, with the software application, the rule group to the second unique mortgage product to define a second specific mortgage product.

As used herein, the terms “loan” or “loan product” refers to an agreement including a set of terms by which a lender will provide funds to a borrower. One of ordinary skill in the art, in view of the disclosure provided herein, will recognize that a mortgage is a loan or loan product that is offered to a borrower by a lender whereby the funds are provided to allow the borrower to purchase or refinance real estate with an agreement that the lender can take the property that is subject to the mortgage if the borrower defaults.

As used herein with reference to mortgages, the term “class” refers to an identification of whether a mortgage is offered or secured by a government entity. One of ordinary skill in the art, in view of the disclosure provided herein, will recognize that a mortgage can be in a “conventional” class or an “FHA” class as two examples.

As used herein with reference to mortgages, the term “category” refers to an identification of an amount of a mortgage relative to a defined limit. One of ordinary skill in the art, in view of the disclosure provided herein, will recognize that a mortgage can be categorized either as a “conforming loan” where the balance is less than or equal to the amount defined by the limit, or a “high balance” or “non-conforming” loan where the balance is above the amount defined by the limit.

As used herein with reference to mortgages, the term “type” refers to an identification of whether the interest rate on the mortgage can vary. One of ordinary skill in the art, in view of the disclosure provided herein, will recognize that a mortgage can be categorized either as a “fixed rate” mortgage where the interest rate is fixed for the full term of the mortgage, or an “adjustable rate” mortgage where the interest rate can vary during the term of the mortgage.

As used herein with reference to mortgages, the term “structure” refers to an identification of the term of one or more fixed rate periods of the mortgage. One of ordinary skill in the art, in view of the disclosure provided herein, will recognize that a mortgage can include a 30 year fixed rate structure, a 15 year fixed rate structure, a 7/1 hybrid ARM structure and a 5/6 hybrid ARM structure to provide a few examples.

As used herein the term unique mortgage product means a mortgage product that has one or more features already defined. For example, one of ordinary skill in the art in view of the disclosure herein will recognize that features of a unique mortgage product can include one or more of the product class, the product category, the product type, and product structure already known. A conforming 30 year fixed provides one example. A conforming 5/6 SOFR ARM provides another.

As used herein the term specific mortgage product means a mortgage product defined by one or more groups of rules applied to a unique mortgage product. The rules impact at least one of: a price level adjustment of a unique mortgage product; a margin on the unique mortgage product; and an eligibility of borrowers for the mortgage product.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 illustrates a first loan pricing approach according to the prior art;

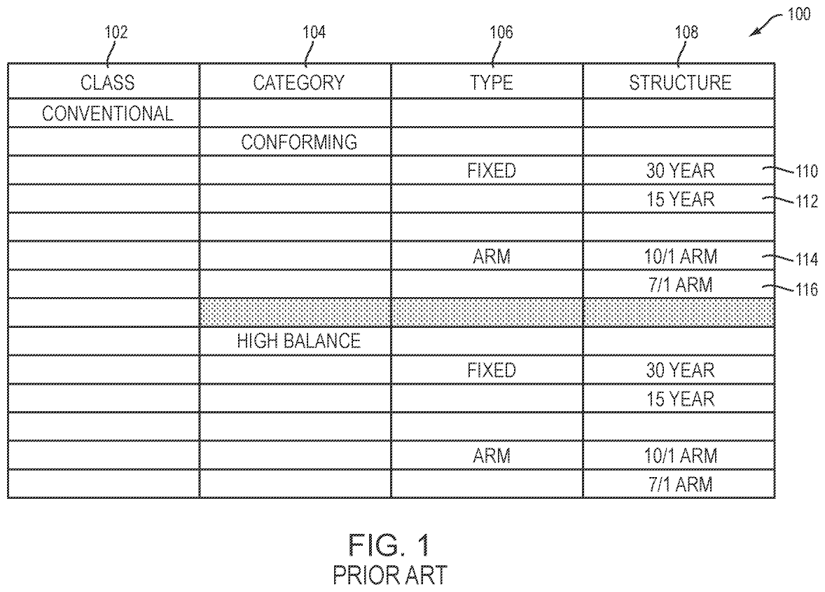

FIG. 2 illustrates a second loan pricing approach according to the prior art;

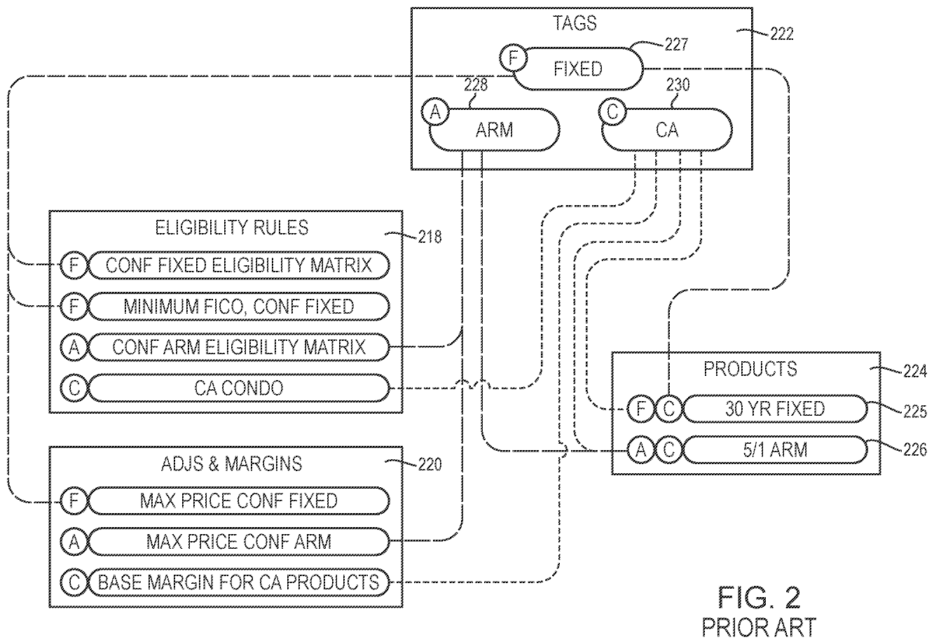

FIG. 3 illustrates a system including a network operating environment for a loan pricing application in accordance with one embodiment;

FIG. 4 illustrates a flow diagram of a process for pricing loans in accordance with one embodiment;

FIG. 5 illustrates a first graphical user interface in accordance with one embodiment;

FIG. 6 illustrates a second graphical user interface in accordance with one embodiment;

FIG. 7 illustrates a third graphical user interface in accordance with one embodiment;

FIG. 8 illustrates a first view of a fourth graphical user interface in accordance with one embodiment; and

FIG. 9 illustrates a second view of the fourth graphical user interface in accordance with one embodiment.

### DETAILED DESCRIPTION

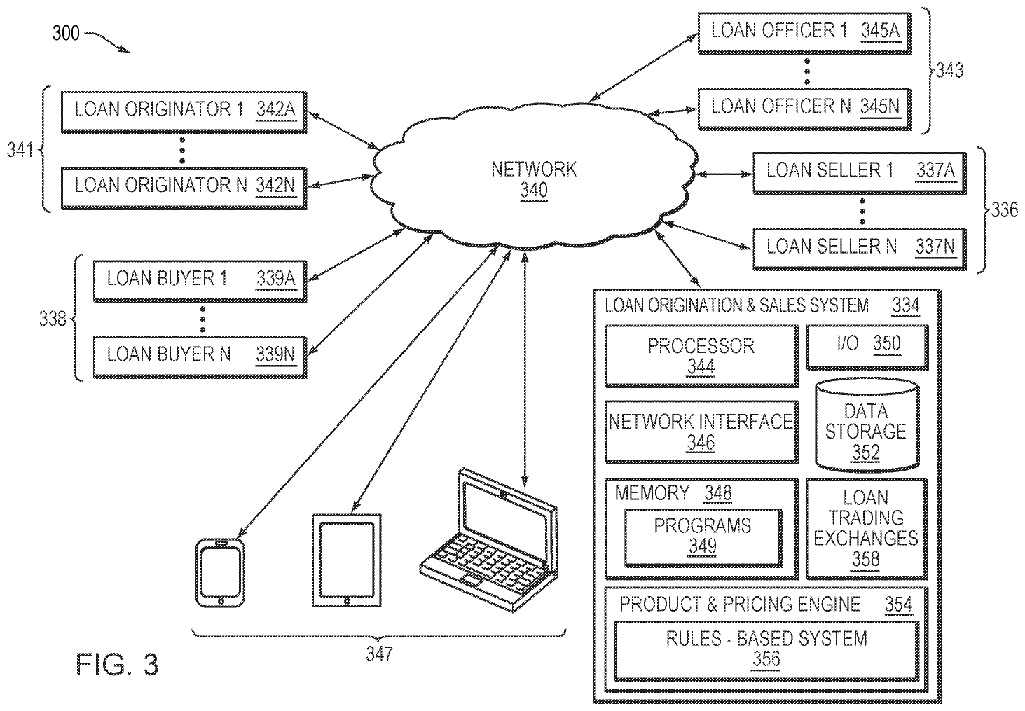

Referring now to FIG. 3, a system 300 for originating and selling loans is illustrated in accordance with various embodiments. According to the illustrated embodiment, the system 300 includes a loan origination and sale system 334, a plurality of loan sellers 336, a plurality of loan buyers 338, a network 340, a plurality of loan originators 341, a plurality of loan officers 343 and a plurality of user devices 347. The plurality of loan sellers 336 includes any of loan seller 1 337A through loan seller N 337N. The plurality of loan buyers 338 includes any of loan buyer 1 339A through loan buyer N 339N. The plurality of loan originators 341 includes any of loan originator 1 342A through loan originator N 342N. The plurality of loan officers 343 includes any of loan officer 1 345A through loan officer N 345N. In general, the plurality of loan originators 341 generate new loan products offered to borrowers via the plurality of loan officers 343, the plurality of loan sellers 336 sell loans that they own on the secondary market and the plurality of loan buyers 338 seek to purchase loans on the secondary market. One of ordinary skill in the art based on the disclosure provided herein, will recognize that a single party (for example, a bank or other financial institution) may be each of a loan originator, a loan seller, and a loan buyer for different loan products in different transactions, respectively.

In various embodiments described in greater detail below, the system 300 can be employed to setup a configuration of a loan product and offer that loan product to borrowers via a loan officer (for example, a mortgage officer or a mortgage broker). The system 300 can also be employed to operate a bid-auction process by a loan seller (any of the loan sellers 337A-337N) for loans offered for sale on the secondary market to buyers included in the plurality of loan buyers 338A-338N.

In general, a system administrator or other operator of the loan origination and sales system 334 is responsible for maintaining and operating the system 334 and providing access to the plurality of loan sellers 336, the plurality of loan buyers 338, the plurality of loan originators 341 and the plurality of loan officers 343 via the network 340. The loan officers offer mortgage products to borrowers at pricing established by the loan originator 341 with the loan origination and sales system 334. For example, the resources included in the loan origination and sales system 334 can be provided as a web application (a SaaS system) employed by the plurality of loan originators 341 to price their loan products and provide them to the plurality of loan officers 342 of institutions that interact with borrowers. One of ordinary skill in the art, in view of the disclosure provided herein, will recognize that the loan origination and sales system 334 includes separate secure accounts accessible to each of the plurality of loan sellers 336, and each of the plurality of loan originators 341, respectively. In addition, one of ordinary skill in the art, in view of the disclosure provided herein, will recognize that the individual buyers 339A-339N selected from the plurality of loan buyers 338 by any one of the loan sellers 337A-337N can vary. For example, some loan buyers may have access to the separate secure bid-auctions offered by a plurality of the sellers 337A-337 N while other buyers 339A-339 N may only have access to bid-auctions offered by one of the plurality of loan sellers 336. Further, the system 300 can also operate to provide the services and functions described herein where a loan seller is also a loan buyer for third party loan sales and vice versa.

In various embodiments, the loan origination and sales system 334 provides the interface and tools for an originator of loans (for example, mortgages) to establish product pricing available to borrowers and to provide access to the products to loan officers. In the illustrated embodiment, the loan origination and sales system includes a processor 344, a network interface 346, a memory 348, I/O 350 and data storage 352. The memory 348 includes at least one program 349. Depending on the embodiment, the loan origination and sales system 334 can include one or more of a variety of computing devices such as a general purpose computer such as a PC, a laptop, a tablet computer, or other computing device. The resources included in the loan origination and sales system 334 can be hosted on one or more servers accessible to the system operator, the plurality of sellers 336, the plurality of buyers 338, the plurality of loan originators and the plurality of loan officers 343 via the network 340. The network interface 346 is employed for communication between the loan origination and sales system 334 and other elements connected to the network 340 including the plurality of sellers 336, the plurality of buyers 338, the plurality of loan originators 341, the plurality of loan officers 343 and the user devices 347.

The memory 348 can store the programs 349 that when executed by the processor 344 render user interfaces in a display included in the loan origination and sales system 334. The user interface can be employed by a user (for example, the loan originator 342A-342N) to operate the loan origination and sales system 334 to perform steps to create unique loan products (for example, mortgages), establish rules used to customize unique loan products, apply groups of rules to multiple different unique loan products to create specific loan products that differ from one another and provide loan officers with the specific loan products that are offered to borrowers.

The I/O 350 can include any of the display in which a graphical user interface (GUI) is presented to the user, a touchscreen controller where, for example, the display is a touchscreen display, or alternatively, a trackpad or mouse used to move a cursor within a GUI. According to further embodiments, the I/O can include an audio system employed with a speech recognition system to allow hands-free interaction with the GUI.

According to some embodiments, the data storage 352 stores information concerning various aspects of the loan origination and sales system 334, for example, the unique loan products of a loan originator, rules and rule groups developed by the loan originator and the specific loan products created with the application of rule groups to different unique loan products of the loan originator. Depending on the embodiment, the data storage 352 can include any of a relational database, object-oriented database, unstructured database, or other database. Further, the data storage 352 can be included in any aspect of a memory system, such as in RAM, ROM, or disc, and may also be separately stored on one or more dedicated data servers included in the loan origination and sales system 334.

According to the illustrated embodiment, the loan origination and sales system includes a product and pricing engine 354 including a rules-based system 356 and loan trading exchanges 358. In various embodiments, the product and pricing engine 354 is employed by loan originators to define/establish the characteristics of the loans offered to borrowers via loan officers. Further, the rules-based system 356 allows the seller to optimize the process by grouping rules together so that they can be applied to loan products for a precise but streamlined generation of loan products.

The loan trading exchanges 358 provide a tool for sellers to organize a pipeline of loans, offer them for sale, receive and evaluate bids, organize the successful bids into virtual pools, make any desired updates to the pools in view of new bids and/or counter offers, and then commit to the sale of the loans. In various embodiments, a graphical user interface rendered in the seller's user device 347 allows the seller to commit to the sale of all loans currently in their pipeline with a single click or another type of act or selection (for example, a touch input) in the graphical user interface.

The components included in the loan origination and sales system 334 can be coupled by one or more communication buses or signal lines. The communication buses can be used for the communication of instructions/commands and data between the illustrated components and between the illustrated components and other components included in the system 334 depending on the embodiment.

In general, the network 340 can include either or both of local-area networks (LANs), wide area networks (WANs), wireless communication, wired communication and may include the Internet. According to a further embodiment, the network 340 provides access to one or more remote devices, servers, application resource management and/or data storage systems. For example, the network 340 can allow communication between any of the loan origination and sales system 334 and the plurality of user devices 347. In general, the system 300 provides for communication of the illustrated components with one another and/or with any of the other resources and devices coupled to the network 340. Communication can occur using any of Wi-Fi networks, Bluetooth communication, cellular networks, satellite communication, and peer-to-peer networks available either alone or in combination with one another via the network 340. Depending on the embodiment, the network 340 may be any type and/or form of network known to those of ordinary skill in the art capable of supporting the operations described herein. Thus, other communication protocols and topologies can also be implemented in accordance with various embodiments.

The plurality of user devices 347 can include any type of computing device suitable for communicating with the loan origination and sales system 334 via the network 340. Accordingly, the plurality of user devices of can include one or more of a variety of computing devices such as a general purpose computer such as a PC, a laptop, a tablet computer, or other computing device. The user devices 347 are representative of the devices employed to access the resources hosted by the loan origination and sales system 334 by system operators, developers, loan sellers 336, loan buyers 338, loan originators 341 and loan officers 343.

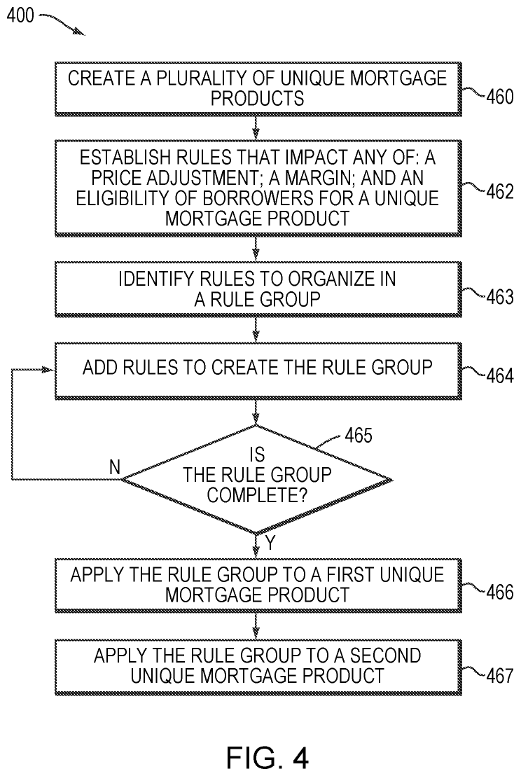

Referring now to FIG. 4, a flow diagram of a process 400 employed for pricing loan products is illustrated in accordance with one embodiment. According to some embodiments, the loan products include new mortgages that are offered to borrowers. The process 400 can be used with the loan origination and sales system 334 to apply logic in the form of groups of rules to one or more unique mortgage products to adjusting pricing, margins and specify borrower qualifications to create specific mortgage products. The result is a process that can save loan originators many hours each day by simplifying workflows used to establish mortgage product pricing. According to the illustrated embodiment, the process 400 is performed using the product and pricing engine 354 including the rules-based system 356.

In various embodiments, the process 400 includes actions and decision points. According to the illustrated embodiments, the actions include an act of creating unique mortgage products 460, an act of establishing rules 462, an act of identifying rules 464 for a rule group, an act of applying a rule group to a first unique mortgage product 466, an act of applying a rule group to a second unique mortgage product 467, and an act of adding individual rules to a rule group 464. According to the illustrated embodiment, the decision point included in the process 400 is an act of determining whether all the rule group is complete 465.

According to the illustrated embodiment, the process 400 starts at the act of creating unique mortgage products 460. With unique mortgage products one or more feature of the mortgage product such as any of the product class, the product category, the product type, and product structure are already known. For example, any conforming mortgage regardless of the type or the structure provide examples of unique mortgage products to which rule-logic can be applied. As another example, a conforming mortgage with a 30 year fixed rate provides a unique mortgage product. However, unlike the single broad feature for the category (conforming) of the preceding “any conforming” mortgage example, three features are known for this second unique mortgage product: each of the category (conforming), type (fixed), and structure (30 years). A change to any one or any combination of these features creates yet another unique mortgage product. For example, a conforming mortgage with an adjustable rate is a further unique mortgage product. Within the conforming/adjustable family of mortgage products, the differences in the structure of the mortgages create further unique mortgage products. A conforming 5/6 SOFR ARM and a conforming 7/1 ARM provide examples of two different conforming/adjustable unique mortgage products. While both products share a common category (conforming) and type (ARM), the structure of the first of these two unique mortgage products includes use of the Secured Overnight Financing Rate (“SOFR”) as the bench mark where the initial interest rate lasts five years followed by rate adjustments every six months. The second of these two unique mortgage products are not tied to the SOFR benchmark and has an initial interest rate lasting seven years followed by annual rate adjustments. In general, a base note rate is established for any unique mortgage product for which all the features (class, category, type, and structure) are known.

Each loan originator 342A-342N can employ the loan origination and sales system 334 to establish rules. These rules are applied to unique products to create specific mortgage products by any one of or combination of: adjusting a price level of a unique mortgage product; a margin on a unique mortgage product; and an eligibility of borrowers for the unique mortgage product. At the act of establishing rules 462, rules are established by a loan originator where the rules can be applied in one or more different groups to one or more different unique mortgage products, for example, using the rule-based system 356 included in the product and pricing engine 354. The product and pricing engine 354 can allow for the creation and application of hundreds of different rules by any one of the loan originators. Further, each loan originator can create their own suite of rules.

The process 400 moves to the act of identifying rules to organize in a selected rule group 463. Here, the user determines which of the available rules to add to a newly configured rule group. As described above, the rules are selected to form rule groups that can be applied to one or more unique mortgage products to create different specific mortgage products. From the act of identifying the rules at the act 463, the process 400 moves to the act of adding rules to create a rule group 464. Here, the user adds the rules selected for the new rule group to the group. At the act of determining whether the rule group is complete 465, the user reviews the set of rules currently in the new group against the rules identified at the act of identifying rules 463. If all the desired rules are not yet included in the new rule group, the user returns to the act of adding rules to create the rule group 464.

With all the desired rules included in the new rule group, the process 400 moves to the act of applying the new rule group to a first unique mortgage product 466. For example, the new rule group can be applied to a unique mortgage product, a conforming 10 year fixed rate mortgage which is available among all the conforming loan products.

The process 400 allows a user to apply the rule group to one or more additional loan products. According to illustrated embodiment, the process 400 moves to the act of applying the rule group to a second unique mortgage product 467. For example, the new rule group can be applied to a different unique mortgage product in the conforming category, a conforming 10/6 SOFR ARM mortgage. The result is an approach that allows an application of logic provided by multiple rules to multiple different loan products, a many-to-many application of rules to loan products which was not available in prior approaches.

Depending on the embodiment, the process 400 can be modified based on preferences of the user. For example, the acts of identifying the rules 463 and the act of adding rules to create a rule group 464 can be combined in a single act where the user reviews the list of rules, selects, and adds the individual rules as a part of the review process. As another variation, the unique mortgage products that new rule group will be applied to one can be identified during the process of creating the rule group before the new rule group is completed.

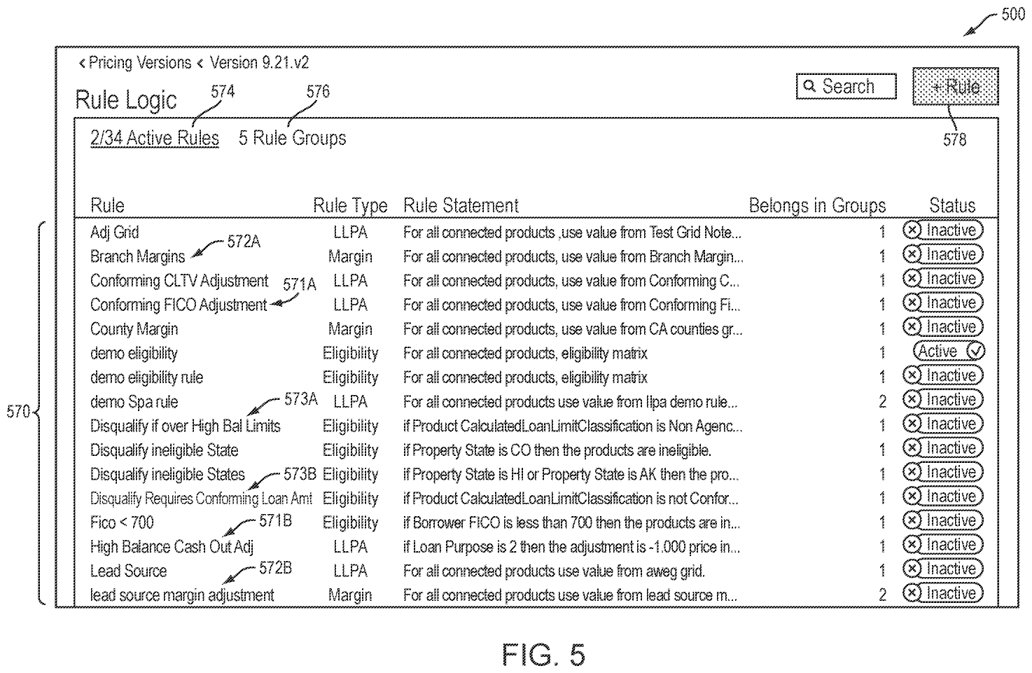

Referring to FIGS. 5-9, user interfaces employed by one or more loan originators are illustrated in accordance with various embodiments. According to various embodiments, the user can employ the computing resources included in the system 334 to create specific mortgage products by identifying unique loan products, creating a plurality of rules, organizing the rules into rule groups, and applying the rule groups to multiple different unique loan products. For example, the user interfaces can be generated by a software application operating as a part of the loan origination and sales system 334. The software application can include one or more programs (e.g., programs 349 of FIG. 3) stored in the memory 348 that when executed by the processor 344 render the user interface in a display included in a respective user device 342 of the loan originator. The embodiments described with reference to FIGS. 5-9 illustrate a series of display objects of a graphical user interface presented in the display to allow a loan originator to interact with the loan origination and sales system 334 to create and apply rule groups to create specific loan products.

Referring to FIG. 5, a user interface 500 is illustrated in accordance with various embodiments. In the illustrated embodiment, the user interface 500 is rendered in a GUI to provide a user with access to the plurality of rules. The user interface 500 includes a plurality of rules 570. Each of the rules may impact loan pricing, a lender's margin, and a borrower's eligibility. For purpose of explanation, six of the plurality of rule 570 are identified in FIG. 5. These are a first rule that impacts loan pricing 571A, a second rule that impacts loan pricing 571B, a first rule that impacts a margin on the loan 572A, a second rule that impacts a margin on the loan 572B, a first rule that impacts the eligibility requirements for borrowers of the loan 573A, and a second rule that impacts the eligibility requirements for borrowers of the loan 573B. The user interface 500 also includes a first graphics element 574 selected for display of the available rules and a second graphics element 576 selected for display of the rule groups created using the system. The user interface 500 includes a third graphics element 578 selected for an addition of a new rule.

Each of the plurality of rules 570 is individually listed with a rule name (“Rule”), a rule type (“Rule Type”), a rule statement (“Rule Statement”), a quantity of applicable groups (“Belongs in Groups”), and an active/inactive state of the rule (“Status”). For example, the first rule that impacts loan pricing 571A has a rule name “Conforming FICO Adjustment,” a rule type “LLPA,” a rule statement “For all connected products use value from Conforming FI . . . ,” a quantity of groups to which it is applied of “1” and a status of “inactive.” This information quickly identifies to the user that this rule invokes a Loan Level Price Adjustment (“LLPA”) to the base note rate of a unique mortgage product to which it is applied. In addition, the user is informed that the rule is applicable to conforming mortgages based on the borrower's FICO score. A user's selection of the active link that appears as the rule name allows the user to see the full details provided in the rule statement column. The information displayed for the rule also quickly identifies to the user that this rule is currently included in a single rule group, and further, that the rule group is not currently applied to any mortgage products. That is, the rule is inactive. In practice, an inactive rule is not applied by the product and pricing engine 354 during processing. However, the rule remains in the system for use with later product pricing.

As another example, the second rule that impacts loan pricing 571B has a rule name “High Balance Cash Out Adjustment,” a rule type “LLPA,” a rule statement “If Loan Purpose is 2 then adjustment is −1.000 price in . . . ” a quantity of groups to which it is applied of “1” and a status of “inactive.” This rule also impacts loan pricing where, for example, a buyer is paying closing costs to reduce the price of the loan. The rule is applicable to mortgage products with a high balance (i.e., not conforming) where the borrower is receiving cash from the mortgage in addition to the funds used to finance the property purchase or refinance.

In another example, the first rule that impacts a margin on the loan 572A, has a rule name “Branch Margins,” a rule type “Margin,” a rule statement “For all connected products, use value from Branch Margin . . . ,” a quantity of “1” and a status of “inactive.” This information quickly identifies to the user that this rule adjusts the margin that the lending branch receives for the unique mortgage product to which it is applied. In addition, the user is informed that the rule is applicable to one group of rules. Like all other listed rules, a user's selection of the active link that appears as the rule name (here, “Branch Margins”) allows the user to see the full details provided in the rule statement column. The information displayed for the rule also quickly identifies to the user that this rule is currently included in a single rule group, and further, that the rule group is not currently applied to any mortgage products. Similarly, the second rule that impacts a margin on the loan 572B, has a rule name “lead source margin adjustment,” a rule type “Margin,” a rule statement “For all connected products, use value from lead source . . . ,” a quantity of “1” and a status of “inactive.” Here, the rule 572B adjusts the margin provided to the lender based on a source of the lead that identified the borrower.

The first rule that impacts the eligibility requirements for borrowers of the loan 573A, has a rule name “Disqualify if over High Bal Limits,” a rule type “Eligibility,” a rule statement “If Product CalculatedLoanLimitClassification is Non Agenc . . . ,” a quantity of “1” and a status of “inactive.” This information quickly identifies to the user that this rule disqualifies borrowers to prevent the origination of loans for amounts that exceed the limits for non-conforming, high balance mortgage products. Again, a user's selection of the active link that appears as the rule name “Disqualify if over High Bal Limits” allows the user to see the full details provided in the rule statement column. Similarly, the second rule that impacts the eligibility requirements for borrowers of the loan 573B, has a rule name “Disqualify Requires Conforming Loan Amt,” a rule type “Eligibility,” a rule statement “If Product CalculatedLoanLimitClassification is not Confor . . . ,” a quantity of “1” and a status of “inactive.” Here, the user can quickly identify that the rule 573B is applicable to conforming mortgage products. Further, that the rule is employed to disqualify borrowers applying for amounts that exceed the conforming mortgage limits.

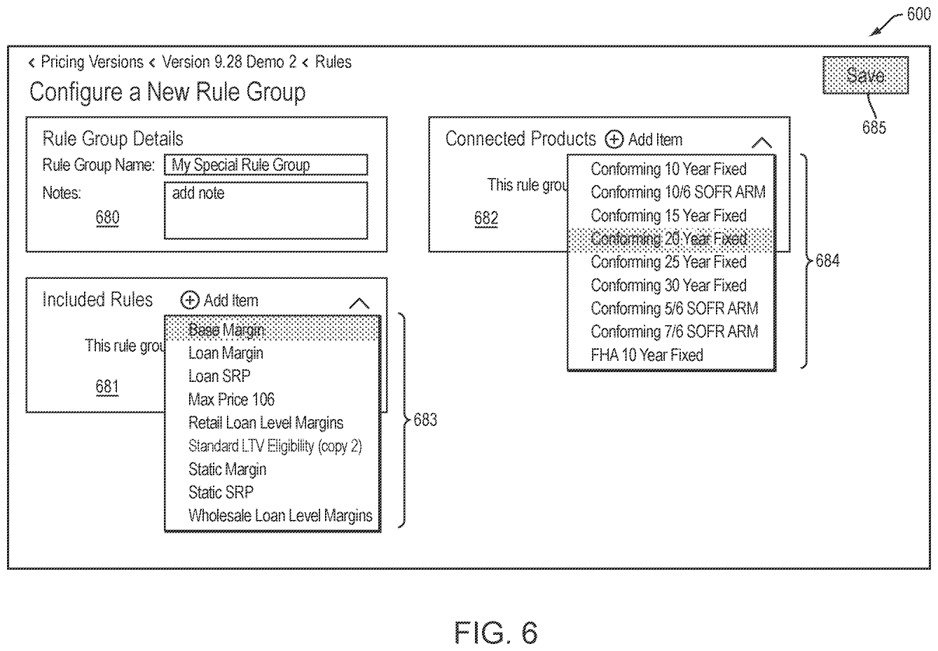

FIG. 6 illustrates a user interface 600 rendered in a GUI employed to configure a new rule group in accordance with one embodiment. The user interface 600 includes rule group details 680, included rules 681 and connected products 682. The included rules 681 includes a first field for selection and display of a plurality of included rules 683 for the new rule group. This first field also allows for an addition of a rule to the rule group as the group is configured. The connected products 682 include a second field for selection and display of a plurality of products 684 that the new rule group is applied to. This second field also allows for the addition of products to which the group is applied. The user interface 600 includes a third display object 685 employed by the user to save a newly configured rule group.

As illustrated in FIG. 6, the plurality of included rules 683 that are currently displayed include a total of nine rules. However, the user can add any one and any combination of all the hundreds of rules available in the loan originator's suite of rules (see FIG. 5). As a result, a rule group can include any combination of rules that impact loan pricing, a lender's margin, or the eligibility of a borrower or product for a specific mortgage product. A user can scroll up or down to see the full list of rules included in the plurality of included rules 683.

Similarly, the plurality of connected products 684 that are currently displayed include a total of nine products. Here, the user can add any of all the unique mortgage products currently offered by the loan originator. As a result, the plurality of listed products can include any set of products. The preceding allows an application of a group of rules to a variety of unique mortgage products. As mentioned above, this allows the user to complete an application of many rules to many mortgage products. This many-to-many application of rule-logic can be completed at the configuration stage via the user interface 600. For example, when the user selects the third display object 685 to save the newly configured rule group.

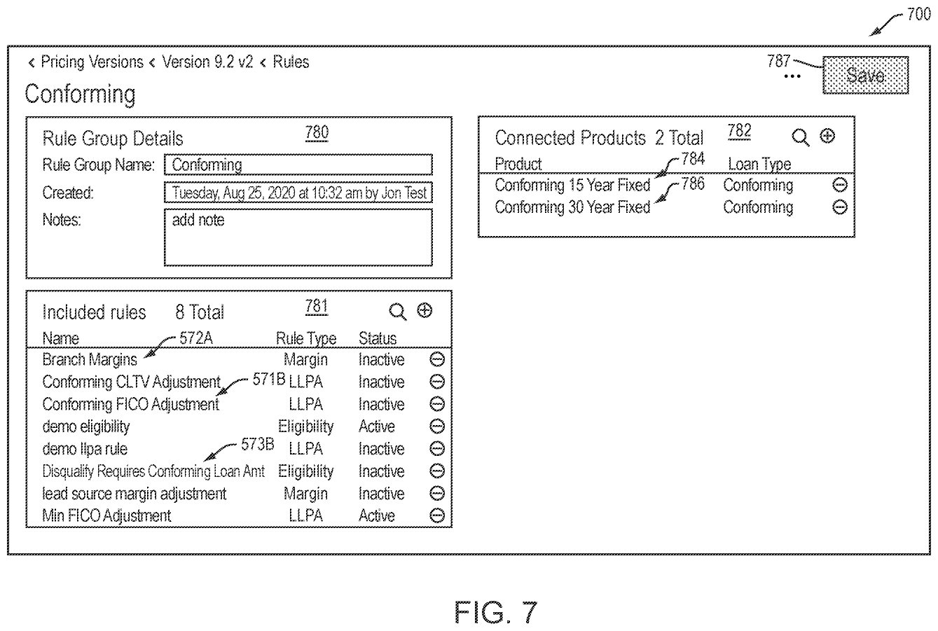

Referring now to FIG. 7, a user interface 700 is illustrated in accordance with various embodiments. In the illustrated embodiment, the user interface 700 is rendered in a GUI to review, modify, and save changes to a previously configured rule group, for example, the new rule group configured as illustrated in FIG. 6. For example, the user can navigate to the user interface 700 to add or remove rules and to add or remove products to the previously configured rule group. The user interface 700 includes the rule group details 780, included rules 781 and connected products 782. The included rules are individually listed with the rule name (“Name”), the rule type (“Rule Type”), and an active/inactive state of the rule (“Status”). These include, for example, the second rule that impacts loan pricing 571B, the first rule that impacts a margin on the loan 572A and second rule that impacts the eligibility requirements for borrowers of the loan 573B. The connected products 782 include a first unique mortgage product 784 (“Conforming 15 Year Fixed”) and a second unique mortgage product 785 (“Conforming 15 Year Fixed”). The user interface 700 includes a fourth display object 787 employed by the user to save changes to the rule group.

The user's ability to add rules is only limited by the total number of rules available in the loan originators suite of rules, see FIG. 5. Thus, the user can later add newly created rules to a previously configured rule group. The user interface 700 also provides the user with the ability to remove rules from an existing rule group. These modifications can reflect changes: in the market for mortgages; the originator's perception of risk; and changes in internal or external regulations governing mortgages. The user selects the fourth display object 787 to save any changes to the rule group.

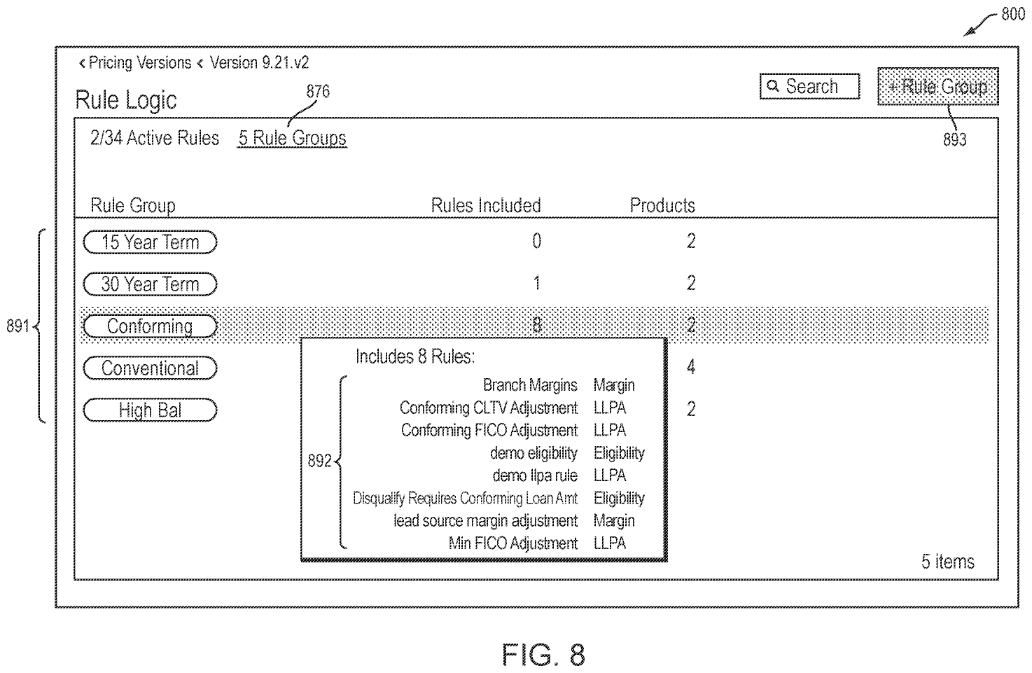

Referring now to FIG. 8, a user interface 800 is illustrated in accordance with various embodiments. In the illustrated embodiment, the user interface 800 is rendered in a GUI to display, review and access rule groups, for example, the “Conforming” rule group as illustrated in FIG. 7. The user interface 800 includes a summary display that individually lists each rule group by name, the quantity of rules included in the respective rule group, and the quantity of mortgage products to which the respective rule group applies. According to the illustrated embodiment, a plurality of rule groups 891 are illustrated. These include a “15 Year Term” rule group, a “30 Year Term” rule group, a “Conforming” rule group, a “Conventional” rule group and a “High Bal” rule group. The user interface 800 also includes a plurality of included rules 892.

For each of the rule groups, active links are provided where the data for each of the quantity of included rules and the quantity of unique mortgage products to which the rule group applies are listed. For example, the plurality of included rules 892 are rendered in FIG. 8 because of a selection of the “8” rules displayed for the “Conforming” rule group. In this example, these include two rules that impact the margin on the mortgage product, two rules that impact the eligibility of borrowers for the mortgage product and four rules that impact the pricing of the mortgage product.

The user interface 800 also includes a fifth display object 893 employed by the user to add a new rule group. For example, a selection of the fifth display object 893 can result in the rendering of the graphical user interface 600 for a configuration of a new rule group.

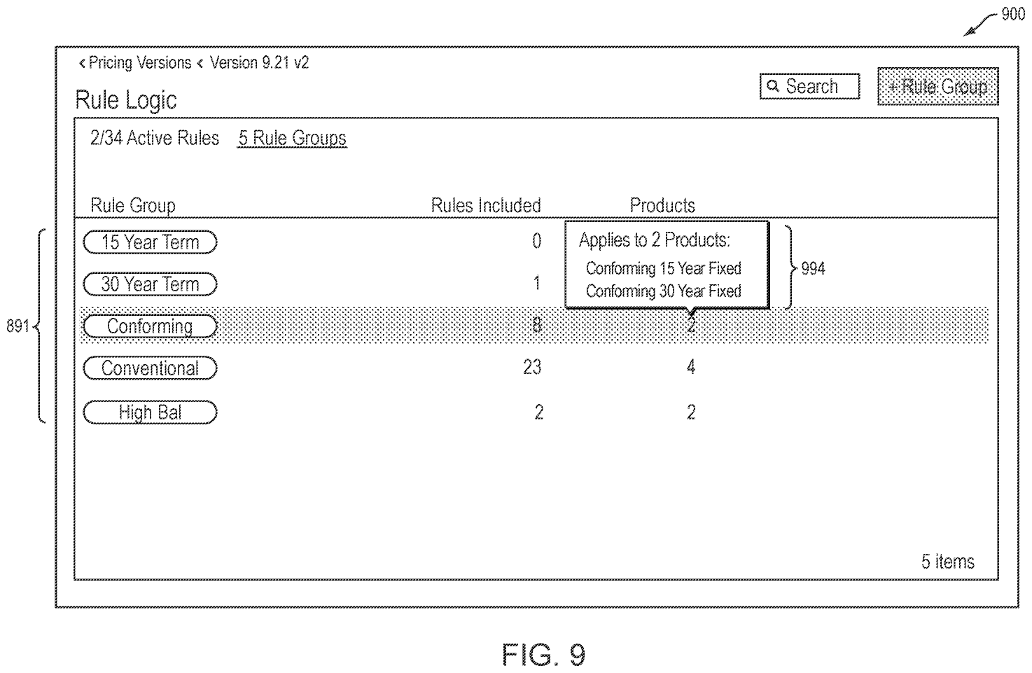

Referring now to FIG. 9, a user interface 900 is illustrated in accordance with various embodiments. In the illustrated embodiment, the user interface 900 displays the same rule groups as illustrated in FIG. 8. However, in FIG. 9 the active link in the “Products” column for the “Conforming” rule group is selected rather than the active link provided in the “Rules Included” column. According to the illustrated embodiment, a plurality of products 994 are illustrated because of the selection of the active link in the “Products” column, the selection of the numeral “2.” The two listed products are a “Conforming 15 Year Fixed” product and a “Conforming 30 Year Fixed” product. Further, each of the listed products is an active link that allows the user to navigate directly to the product details with a selection of the product name from the plurality of products 994.

The user interfaces 800, 900 allow a user to quickly identify a rule group, and directly navigate to every rule included in the group, The user interfaces also allow users to directly navigate to each of the products to which the rule group is applied. These embodiments facilitate the efficient customization of rule groups and application of rule groups to products to create specific mortgage products using one or more customized rule group applied to the same unique mortgage product. For example, each of the “15 Year Term” rule group and the “Conforming” rule group can be applied to all the loan originator's “Conforming 15 Year Fixed” mortgage products. This facilitates the generation of product pricing for multiple different specific mortgage products.

The techniques described above may be implemented, for example, in hardware, one or more computer programs tangibly stored on one or more computer-readable media, firmware, or any combination thereof. The techniques described above may be implemented in one or more computer programs executing on (or executable by) a programmable computer including any combination of any number of the following: a processor, a storage medium readable and/or writable by the processor (including, for example, volatile and non-volatile memory and/or storage elements), an input device, and an output device. Program code may be applied to input entered using the input device to perform the functions described and to generate output using the output device.

Embodiments of the present invention include features which are only possible and/or feasible to implement with the use of one or more computers, computer processors, and/or other elements of a computer system. Such features are either impossible or impractical to implement mentally and/or manually. Organizing multiple rules into rule groups and the application of the rule groups to multiple different mortgage products provide two such examples.

Each computer program within the scope of the claims below may be implemented in a computer program product tangibly embodied in a machine-readable storage device for execution by a computer processor. Method steps of the invention may be performed by one or more computer processors executing a program tangibly embodied on a computer-readable medium to perform functions of the invention by operating on input and generating output. Suitable processors include, by way of example, both general and special purpose microprocessors.

Any step or act disclosed herein as being performed, or capable of being performed, by a computer or other machine, may be performed automatically by a computer or other machine, whether explicitly disclosed as such herein. A step or act that is performed automatically is performed solely by a computer or other machine, without human intervention. A step or act that is performed automatically may, for example, operate solely on inputs received from a computer or other machine, and not from a human. A step or act that is performed automatically may, for example, be initiated by a signal received from a computer or other machine, and not from a human. A step or act that is performed automatically may, for example, provide output to a computer or other machine, and not to a human.

While the above description and associated figures are described in the context of the pricing of mortgage products, the approaches described herein can also be employed in the pricing of other types of loans or loan products.

Having thus described several aspects of at least one embodiment of this invention, it is to be appreciated that various alterations, modifications, and improvements will readily occur to those skilled in the art. Such alterations, modifications, and improvements are intended to be part of this disclosure and are intended to be within the spirit and scope of the invention. Accordingly, the foregoing description and drawings are by way of example only.

What is claimed is:

1. A computer implemented method for a mortgage originator to define a specific mortgage product offered to borrowers, the specific mortgage product defined using a software application accessible via a graphical user interface presented in a display, the method comprising:
establishing, with the software application, a plurality of rules available to apply to unique mortgage products, each of the plurality of rules associated with at least one of: classes of the unique mortgage products; categories of the unique mortgage products; types of the unique mortgage products; structures of the unique mortgage products; factors concerning a borrower of the unique mortgage products; and factors concerning a nature of a property subject to the unique mortgage products;
establishing, with the software application, a first unique mortgage product, the first unique mortgage product characterized by at least one of a class, a category, a type, and a structure of the first unique mortgage product;
establishing, with the software application, a second unique mortgage product that is different than the first unique mortgage product, the second unique mortgage product characterized by at least one of a class, a category, a type, and a structure of the second unique mortgage product;
configuring, with the software application, a rule group including a combination of rules selected from the plurality of rules;
applying, with the software application, the rule group to the first unique mortgage product to define a first specific mortgage product; and
applying, with the software application, the rule group to the second unique mortgage product to define a second specific mortgage product.

2. The computer implemented method of claim 1, wherein each of the plurality of rules impacts at least one of: a price level adjustment of a mortgage product to which the respective one of the plurality of rules is applied; a margin on the mortgage product to which the respective one of the plurality of rules is applied; and an eligibility of borrowers for the mortgage product to which the respective one of the plurality of rules is applied.

3. The computer implemented method of claim 1, wherein each of the class of the first unique mortgage product, the category of the first unique mortgage product, the type of the first unique mortgage product and the structure of the first unique mortgage product are defined.

4. The computer implemented method of claim 3, wherein the classes of the unique mortgage products include at least a conventional mortgage,
wherein the categories of the unique mortgage products include at least one of a conforming mortgage product and a high balance mortgage product,
wherein the types of the unique mortgage products include at least one of a fixed rate mortgage product and an adjustable rate mortgage product, and
wherein the structures of the unique mortgage products include at least one of a fixed term mortgage product and a combined fixed and adjustable term mortgage product.

5. The computer implemented method of claim 1, further comprising:
configuring the graphical user interface to allow a user employing the application to add individual rules included in the plurality of rules to the rule group and select a plurality of unique mortgage products for association with the rule group; and
applying each of the individual rules included in the rule group, respectively, to each of the plurality of unique mortgage products in response to a single user input received via the user via the graphical user interface.

6. The computer implemented method of claim 5, wherein the application of the rule group to each of the plurality of mortgage products occurs substantially simultaneously.

7. The computer implemented method of claim 5, wherein the single user input is a first single user input, and wherein the method further comprises:
configuring the graphical user interface to allow the user employing the application to add individual rules to a previously configured rule group; and
applying each of the added individual rules, respectively, to each of the plurality of unique mortgage products in response to a second single user input received via the graphical user interface.

8. The computer implemented method of claim 5, wherein the single user input is a first single user input, and wherein the method further comprises:
configuring the graphical user interface to allow the user employing the application to add at least one additional mortgage product for association with the rule group; and
applying the plurality of rules included in the rule group to the at least one additional mortgage product in response to a second single user input received via the user via the graphical user interface.

9. The computer implemented method of claim 5, wherein the plurality of unique mortgage products includes each of a first unique mortgage product and a second unique mortgage product, and wherein the method further comprises:
establishing a first specific mortgage product with an application of the plurality of rules included in the rule group to the first unique mortgage product; and
establishing a second specific mortgage product with an application of the plurality of rules included in the rule group to the second unique mortgage product, the second specific mortgage product being different than the first specific mortgage product.

10. A non-transitory computer-readable medium comprising computer program instructions executable by at least one computer processor to perform a method to define a specific mortgage product offered to borrowers by a mortgage originator, the specific mortgage product defined using a software application accessible via a graphical user interface presented in a display, the method comprising:
establishing, with the software application, a plurality of rules available to apply to unique mortgage products, each of the plurality of rules associated with at least one of: classes of the unique mortgage products; categories of the unique mortgage products; types of the unique mortgage products; structures of the unique mortgage products; factors concerning a borrower of the unique mortgage products; and factors concerning a nature of a property subject to the unique mortgage products;
establishing, with the software application, a first unique mortgage product, the first unique mortgage product characterized by at least one of a class, a category, a type, and a structure of the first unique mortgage product;
establishing, with the software application, a second unique mortgage product that is different than the first unique mortgage product, the second unique mortgage product characterized by at least one of a class, a category, a type, and a structure of the second unique mortgage product;
configuring, with the software application, a rule group including a combination of rules selected from the plurality of rules;
applying, with the software application, the rule group to the first unique mortgage product to define a first specific mortgage product; and
applying, with the software application, the rule group to the second unique mortgage product to define a second specific mortgage product.

11. The non-transitory computer readable medium of claim 10, wherein each of the plurality of rules impacts at least one of: a price level adjustment of a mortgage product to which the respective one of the plurality of rules is applied; a margin on the mortgage product to which the respective one of the plurality of rules is applied; and an eligibility of borrowers for the mortgage product to which the respective one of the plurality of rules is applied.

12. The non-transitory computer readable medium of claim 10, wherein each of the class of the first unique mortgage product, the category of the first unique mortgage product, the type of the first unique mortgage product and the structure of the first unique mortgage product are defined.

13. The non-transitory computer readable medium of claim 12, wherein the classes of the unique mortgage products include at least a conventional mortgage,
wherein the categories of the unique mortgage products include at least one of a conforming mortgage product and a high balance mortgage product,
wherein the types of the unique mortgage products include at least one of a fixed rate mortgage product and an adjustable rate mortgage product, and
wherein the structures of the unique mortgage products include at least one of a fixed term mortgage product and a combined fixed and adjustable term mortgage product.

14. The non-transitory computer readable medium of claim 10, further comprising:
configuring the graphical user interface to allow a user employing the application to add individual rules included in the plurality of rules to the rule group and select a plurality of unique mortgage products for association with the rule group; and
applying each of the individual rules included in the rule group, respectively, to each of the plurality of unique mortgage products in response to a single user input received via the user via the graphical user interface.

15. The non-transitory computer readable medium of claim 14, wherein the application of the rule group to each of the plurality of mortgage products occurs substantially simultaneously.

16. The non-transitory computer readable medium of claim 14, wherein the single user input is a first single user input, and wherein the method further comprises:
configuring the graphical user interface to allow the user employing the application to add individual rules to a previously configured rule group; and
applying each of the added individual rules, respectively, to each of the plurality of unique mortgage products in response to a second single user input received via the graphical user interface.

17. The non-transitory computer readable medium of claim 14, wherein the single user input is a first single user input, and wherein the method further comprises:
configuring the graphical user interface to allow the user employing the application to add at least one additional mortgage product for association with the rule group; and
applying the plurality of rules included in the rule group to the at least one additional mortgage product in response to a second single user input received via the user via the graphical user interface.

18. The non-transitory computer readable medium of claim 14, wherein the plurality of unique mortgage products includes each of a first unique mortgage product and a second unique mortgage product, and wherein the method further comprises:
establishing a first specific mortgage product with an application of the plurality of rules included in the rule group to the first unique mortgage product; and
establishing a second specific mortgage product with an application of the plurality of rules included in the rule group to the second unique mortgage product, the second specific mortgage product being different than the first specific mortgage product.
